(19) United States
(12) Patent Application Publication
(10) Pub. No.: US 2025/0391601 A1
(43) Pub. Date: Dec. 25, 2025

(54) INDUCTOR AND METHOD OF MANUFACTURING INDUCTOR

(71) Applicant: Murata Manufacturing Co., Ltd., Kyoto-fu (JP)

(72) Inventors: Kouhei OSAKI, Nagaokakyo-shi (JP); Akinori HAMADA, Nagaokakyo-shi (JP); Minoru GIBU, Nagaokakyo-shi (JP)

(73) Assignee: Murata Manufacturing Co., Ltd., Kyoto-fu (JP)

(21) Appl. No.: 19/307,758

(22) Filed: Aug. 22, 2025

Related U.S. Application Data
(63) Continuation of application No. PCT/JP2024/018672, filed on May 21, 2024.

(30) Foreign Application Priority Data
Jun. 1, 2023 (JP) 2023-090999

(51) Int. Cl. H01F 27/29; H01F 27/255; H01F 41/02; H01F 41/04

(52) U.S. Cl. CPC H01F 27/292; H01F 27/255; H01F 41/0206; H01F 41/04

(57) ABSTRACT

An inductor and a method of manufacturing an inductor with reduced abnormal formation of an external terminal. An inductor includes an element body including a coil conductor inside and containing metal magnetic particles and a resin, and an external terminal at a mounting surface (a first principal surface) of the element body and electrically connected to the coil conductor. The element body includes first and second principal surfaces opposed to each other in a height direction, first and second end surfaces opposed to each other in a length direction orthogonal to the height direction, and first and second side surfaces opposed to each other in a width direction orthogonal to the length and height directions. The external terminal includes a coil conductor connection region on an exposed region where the coil conductor is exposed from the element body in see-through plan view from the mounting surface side.

### CROSS-REFERENCE TO RELATED APPLICATIONS

This application claims benefit of priority to International Patent Application No. PCT/JP2024/018672, filed May 21, 2024, and to Japanese Patent Application No. 2023-090999, filed Jun. 1, 2023, the entire contents of each are incorporated herein by reference.

### BACKGROUND

### Technical Field

The present disclosure relates to an inductor and a method of manufacturing an inductor.

### Background Art

Japanese Unexamined Patent Application Publication No. 2022-18910 discloses an inductor including a composite body formed from a composite material of a resin and metal magnetic powder, an internal electrode provided inside the composite body and having an end surface exposed from an outer surface of the composite body, and an external terminal electrically connected to the internal electrode. Moreover, according to FIG. 1 of Japanese Unexamined Patent Application Publication No. 2022-18910, it is observed that a plane area of the external terminal is larger than a plane area of the internal electrode in see-through plan view. That is to say, it is possible to grasp that the external terminal is in contact with the composite body that contains the metal magnetic powder.

### SUMMARY

The external terminal of the inductor is electrically connected to an electrode of a mounting substrate that mounts the inductor. When the inductor is mounted on the mounting substrate, an increase in the plane area of the external terminal may be desired in light of alignment with the mounting substrate. When the plane area of the external terminal is increased, the external terminal comes into contact with the composite body (an element body of the inductor) located around the internal electrode.

Here, in a case where the external terminal is formed by plating (electroless plating, for instance), a plating formation mechanism to be applied to the internal electrode is different from a plating formation mechanism to be applied to the composite body containing the metal magnetic powder. Specifically, formation of the external terminal by plating causes plating growth attributed to the metal magnetic powder contained in the composite body and develops abnormal formation of the external terminal. Thus, there has been a risk of reduction in yields of the inductors.

Accordingly, the present disclosure provides an inductor and a method of manufacturing an inductor with reduced abnormal formation of an external terminal.

An inductor of the present disclosure includes an element body including a coil conductor inside and containing metal magnetic particles and a resin; and an external terminal provided at a mounting surface of the element body and electrically connected to the coil conductor. The element body includes a first principal surface and a second principal surface opposed to each other in a height direction, a first end surface and a second end surface opposed to each other in a length direction which orthogonal to the height direction, and a first side surface and a second side surface opposed to each other in a width direction orthogonal to the length direction and the height direction. The external terminal includes a coil conductor connection region located on an exposed region where the coil conductor is exposed from the element body in see-through plan view from the mounting surface side of the element body, and an overlap region overlapping the element body. An average length of contact of the metal magnetic particles with the external terminal relative to a length of the overlap region of the external terminal in a cross-section taken from the mounting surface side of the element body in the height direction of the element body along the length direction of the element body at a position where the cross-section passes through the external terminal and the coil conductor connection region is equal to or below 10%.

Another inductor of the present disclosure includes an element body including a coil conductor inside and containing metal magnetic particles and a resin; and an external terminal provided at a mounting surface of the element body and electrically connected to the coil conductor. The external terminal is disposed on an inner side of an exposed region where the coil conductor is exposed from the element body in see-through plan view from the mounting surface side of the element body.

A method of manufacturing an inductor of the present disclosure includes an element

body forming step of forming an element body including a coil conductor inside and containing metal magnetic particles and a resin; an exposing step of exposing an external terminal connection region of the coil conductor from the element body; a particle removing step of removing the metal magnetic particles from a mounting surface of the element body; and an external terminal forming step of forming an external terminal at a particle removal location where the metal magnetic particles have been removed in the particle removing step and the external terminal connection region of the coil conductor exposed in the exposing step.

Another method of manufacturing an inductor of the present disclosure includes an element body forming step of forming an element body including a coil conductor inside and containing metal magnetic particles and a resin; an exposing step of exposing an external terminal connection region of the coil conductor from the element body; and an external terminal forming step of forming an external terminal on an inner side of an exposed region where the external terminal connection region of the coil conductor is exposed from the element body

According to the present disclosure, it is possible to provide an inductor and a method of manufacturing an inductor with reduced abnormal formation of an external terminal. More specifically, in the inductor of the present disclosure, the average length of contact of the metal magnetic particles with the external terminal relative to the length of the overlap region of the external terminal in the cross-section taken from the mounting surface side of the element body in the height direction of the element body along the length direction of the element body at the position where the cross-section passes through the external terminal and the coil conductor connection region is equal to or below 10%. Accordingly, the plating growth attributed to the metal magnetic particles can be reduced. As a consequence, it is possible to reduce abnormal formation of the external terminal.

In addition, in the other inductor of the present disclosure, the external terminal is disposed on the inner side of the exposed region where the coil conductor is exposed from the element body in see-through plan view from the mounting surface side of the element body. Accordingly, it is possible to prevent the metal magnetic particles from coming into contact with the external terminal and to reduce abnormal formation of the external terminal.

### BRIEF DESCRIPTION OF THE DRAWINGS

FIG. 1 is a perspective view of an inductor of the present disclosure;

FIG. 2 is an exploded perspective view of an inductor of a first embodiment;

FIG. 3 is a cross-sectional view in a direction of arrows which is taken along line III-III in FIG. 2;

FIG. 4 is an enlarged cross-sectional view of a principal part in FIG. 3;

FIG. 5 is an exploded perspective view of an inductor of a second embodiment;

FIG. 6 is a cross-sectional view in a direction of arrows which is taken along line VI-VI in FIG. 5;

FIG. 7 is an enlarged cross-sectional view of a principal part in FIG. 6;

FIG. 8 is an enlarged cross-sectional view of a principal part of an inductor according to a modification of the second embodiment;

FIG. 9 is a cross-sectional view of an inductor of another embodiment;

FIG. 10 is a flowchart showing a method of manufacturing an inductor of the present disclosure;

FIG. 11 shows elemental analysis photographs for explaining results of an elemental analysis;

FIG. 12 shows cross-sectional views for explaining a state after particle removal of metal magnetic particles;

FIG. 13 shows cross-sectional views for explaining a state after plating formation;

FIG. 14 shows cross-sectional photographs for explaining a state of contact of metal magnetic particles with an external terminal;

FIG. 15 is a perspective view of another embodiment of the inductor of the present disclosure;

FIG. 16 is an exploded perspective view of the other embodiment of the inductor of the present disclosure;

FIG. 17 is a cross-sectional view in a direction of arrows which is taken along line XVII-XVII in FIG. 16;

FIG. 18 is a perspective view of still another embodiment of the inductor of the present disclosure; and

FIG. 19 is an exploded perspective view of still the other embodiment of the inductor of the present disclosure.

### DETAILED DESCRIPTION

An inductor of the present disclosure will be described below. It is to be noted that the present disclosure is not limited to the following configurations, and may be modified as appropriate within the range not departing from the gist of the present disclosure. Moreover, a combination of individual preferred configurations described below will also be encompassed by the present disclosure.

An inductor of the present disclosure is used in a DC-DC converter, for example. In addition, the inductor of the present disclosure is also applicable to uses other than the DC-DC converter.

In the present specification, terms indicating relations among elements (such as “parallel” and “orthogonal”) and terms indicating shapes of the elements not only mean literal and strict forms but also mean substantially equivalent ranges such as ranges including differences around several percent. Note that a direction of lamination of magnetic layers and coil conductors constituting an element body will be referred to as a “direction of lamination” in the present specification.

In addition, in the description of the present specification, statements concerning directions, orientations, and the like are made simply for the sake of convenience of explanation and are not intended to limit the scope of the present disclosure unless otherwise expressly described. For example, relative terms such as “out (or outer side, outer part, and outer periphery)”, “in (or inner side, inner part, and inner periphery)” as well as derivative terms therefrom, and the like should be understood to state directions as described or as illustrated. That is to say, the present disclosure does not need to be limited to specific directions, orientations, forms, and the like unless otherwise expressly described. In addition, the same applies to terms such as “provided”, “disposed”, “connected”, “in contact”, “attached”, and the like as well as derivative terms therefrom. These terms may represent not only direct forms but also forms in which other elements such as intervening elements are interposed unless otherwise expressly described.

The drawings shown below are schematic diagrams and dimensions, scales such as aspect ratios, and the like may be different from those of actual products in some cases.

### Inductor of First Embodiment

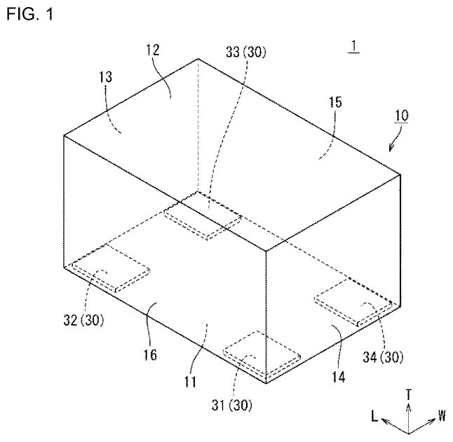

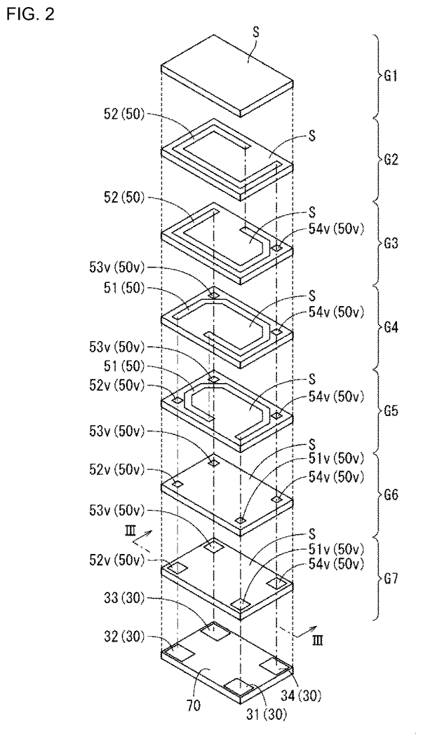

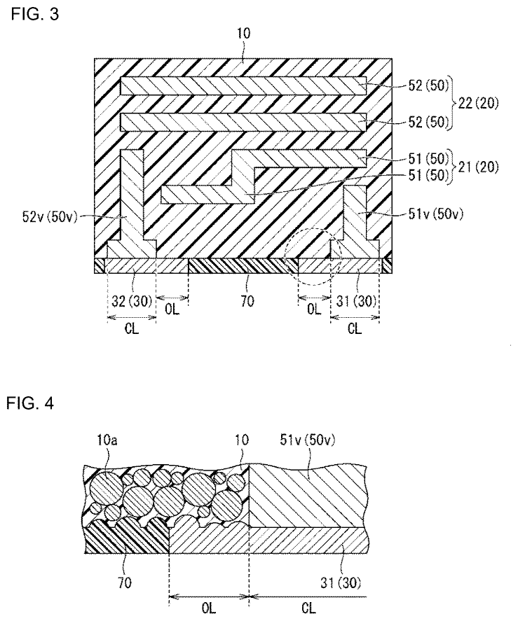

An inductor of a first embodiment of the present disclosure will be described with reference to FIGS. 1 to 4. FIG. 1 is a perspective view of an inductor of the present disclosure, FIG. 2 is an exploded perspective view of an inductor of a first embodiment, FIG. 3 is a cross-sectional view in a direction of arrows which is taken along line III-III in FIG. 2, and FIG. 4 is an enlarged cross-sectional view of a principal part in FIG. 3. Note that shapes, arrangements, and the like of the inductor and respective constituents are not limited to the illustrated examples.

An inductor 1 of the present disclosure includes an element body 10 including coil conductors 50 inside and containing metal magnetic particles 10a and a resin, an insulating layer 70 provided at a mounting surface (a first principal surface 11) of the element body 10 and provided in a region of the mounting surface of the element body 10 including the coil conductors 50 inside, the region not being provided with external terminals 30, and the external terminals 30 electrically connected to the coil conductors 50.

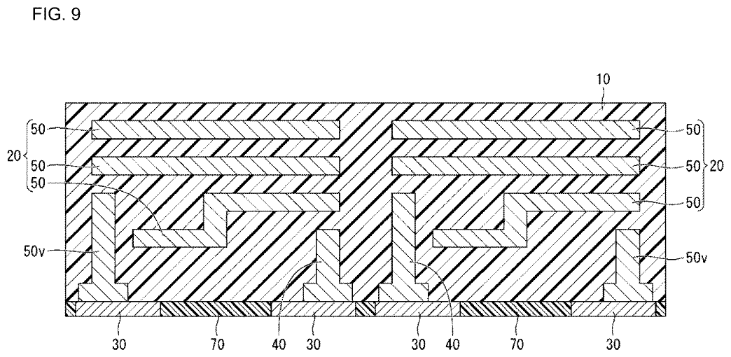

In the present embodiment, the element body 10 includes a first coil 21 and a second coil 22 which are provided on an upper side of the first coil 21 in a height direction T. Here, the coils provided inside the element body 10 are not limited to the above-mentioned form, and a form including one coil or a form including two or more coils is acceptable. For example, a form including four coils in the element body 10 as shown in FIG. 9 is acceptable. In addition, the first coil 21 may be formed by helically winding first coil conductors 51 with via conductors (not shown) interposed therebetween while laminating multiple lamination groups G4 and G5 (see FIG. 2) to be described later. The second coil 22 may be formed by helically winding second coil conductors 52 with via conductors (not shown) interposed therebetween while laminating multiple lamination groups G2 and G3 (see FIG. 2) to be described later. Respective constituents will be described below in detail. -Element body-

The element body 10 has either a rectangular parallelepiped shape or a substantially rectangular parallelepiped shape having six surfaces, for example. Corner portions and ridge portions of the element body 10 may be rounded. A corner portion is a portion where three surfaces of the element body 10 meet while a ridge portion is a portion where two surfaces of the element body 10 meet.

In FIG. 1, a length direction, a width direction, and a height direction of the inductor 1 and of the element body 10 are indicated as an L direction, a W direction, and a T direction, respectively. The length direction L, the width direction W, and the height direction T are orthogonal to one another. A mounting surface of the inductor 1 is a surface (LW surface) which is parallel to the length direction L and the width direction W, for example.

The element body 10 shown in FIG. 1 includes the first principal surface 11 and a second principal surface 12 opposed to each other in the height direction T, a first end surface 13 and a second end surface 14 opposed to each other in the length direction L which orthogonal to the height direction T, and a first side surface 15 and a second side surface 16 opposed to each other in the width direction W orthogonal to the length direction L and the height direction T. In the example shown in FIG. 1, the first principal surface 11 of the element body 10 corresponds to the mounting surface (a bottom surface) of the element body 10. Here, the second principal surface 12 may be the mounting surface of the element body 10.

The element body 10 includes magnetic layers S and the coil conductors 50 (see FIG. 2). In addition, the element body 10 may have a multilayer structure. Specifically, the element body 10 may include the multiple magnetic layers S and the coil conductors 50 in the direction of lamination (such as the height direction T). In the present embodiment, the element body 10 is formed by laminating lamination groups G1 to G7 each including at least one layer of the magnetic layer S and the coil conductor 50 (or including the magnetic layer S only) as shown in FIG. 2. Here, boundaries between the respective layers of the multilayer structure of the element body 10 are lost. Alternatively, the respective lamination group layers may be formed by laminating multiple layers each including the same pattern.

The lamination group G1 includes a magnetic layer S and constitutes the second principal surface 12 of the element body 10.

The lamination group G2 includes a magnetic layer S and a second coil conductor 52 that constitutes part of the second coil 22. The second coil conductor 52 of the lamination group G2 forms one turn of the second coil 22. More specifically, the second coil conductor 52 is disposed substantially along an outer peripheral edge of the magnetic layer S. In addition, one of end portions of the second coil conductor 52 is provided with a conductive layer (or a via conductor) (not shown) to be connected to a second coil conductor 52 of the lamination group G3, and the other end portion of the second coil conductor 52 is provided with a fourth coil conductor connector (not shown) to be electrically connected to a fourth external terminal 34.

The lamination group G3 includes a magnetic layer S and the second coil conductor 52 that constitutes part of the second coil 22. The second coil conductor 52 of the lamination group G3 forms another turn of the second coil 22. One of end portions of the second coil conductor 52 is connected to the second coil conductor 52 of the lamination group G2, and the other end portion of the second coil conductor 52 is provided with a third coil conductor connector (not shown) to be electrically connected to a third external terminal 33. In addition, a corner portion of the magnetic layer S located away from the second coil conductor 52 in plan view is provided with a fourth coil conductor connector 54v in such a way as to be electrically connected to the fourth coil conductor connector (not shown) of the lamination group G2.

The lamination group G4 includes a magnetic layer S and a first coil conductor 51 that constitutes part of the first coil 21. The first coil conductor 51 of the lamination group G4 forms one turn of the first coil 21. One of end portions of the first coil conductor 51 is provided with a conductive layer (or a via conductor) (not shown) to be connected to a first coil conductor 51 of the lamination group G5, and the other end portion of the first coil conductor 51 is provided with a second coil conductor connector (not shown) to be electrically connected to a second external terminal 32. In addition, corner portions of the magnetic layer S located away from the first coil conductor 51 in plan view are provided with a fourth coil conductor connector 54v in such a way as to be electrically connected to the fourth coil conductor connector of the lamination group G3, and provided with a third coil conductor connector 53v in such a way as to be electrically connected to the third coil conductor connector of the lamination group G3.

The lamination group G5 includes a magnetic layer S and a first coil conductor 51 that constitutes part of the first coil 21. The first coil conductor 51 of the lamination group G5 forms another turn of the first coil 21. One of end portions of the first coil conductor 51 is connected to the first coil conductor 51 of the lamination group G4, and the other end portion of the first coil conductor 51 is provided with a first coil conductor connector (not shown) to be electrically connected to a first external terminal 31. In addition, corner portions of the magnetic layer S located away from the first coil conductor 51 in plan view are provided with a fourth coil conductor connector 54v in such a way as to be electrically connected to the fourth coil conductor connector 54v of the lamination group G4, provided with a third coil conductor connector 53v in such a way as to be electrically connected to the third coil conductor connector 53v of the lamination group G4, and provided with a second coil conductor connector 52v in such a way as to be electrically connected to the second coil conductor connector 52v of the lamination group G4.

The lamination group G6 includes a magnetic layer S as well as a first coil conductor connector 51v, a second coil conductor connector 52v, a third coil conductor connector 53v, and a fourth coil conductor connector 54v located at corner portions.

The lamination group G7 includes a magnetic layer S, and a first coil conductor connector 51v, a second coil conductor connector 52v, a third coil conductor connector 53v, and a fourth coil conductor connector 54v located at corner portions, which are larger in plane area than those of the first to fourth coil conductor connectors of the lamination group G6. By setting the plane areas of the first to fourth coil conductor connectors of the lamination group G7 larger than the plane areas of the first to fourth coil conductor connectors of the lamination group G6, alignment of the coil conductor connectors with one another can easily be carried out.

Design freedom of the inductor 1 is enhanced more when the element body 10 has the multilayer structure including the lamination groups G1 to G7 as described above. For example, in a case of manufacturing the inductor 1 including the first external terminal 31, the second external terminal 32, the third external terminal 33, and the fourth external terminal 34 on the bottom surface (the first principal surface 11) of the element body 10, it is easier to extend the first coil 21 and the second coil 22 to the bottom surface side. Here, the above-described multilayer structure including the lamination groups G1 to G7 may be formed by sequentially stacking a material constituting the magnetic layers S, a material constituting the coil conductors 50, and a material constituting coil conductor connectors 50v by printing (such as screen printing) from the second principal surface 12 side or the first principal surface 11 side of the element body 10. In this case, each of the lamination groups G1 to G7 may be formed by repeated printing until each of the magnetic layer S, the coil conductor 50, and the coil conductor connector 50v thereof reaches a desired thickness.

Each magnetic layer S includes the metal magnetic particles 10a (see FIG. 4) made of a magnetic material. The metal magnetic particles 10a may contain Fe and/or Si. More specifically, the metal magnetic particles 10a may be Fe particles or Fe alloy particles. The Fe alloy may be an Fe—Si-based alloy, an Fe—Si—Cr-based alloy, an Fe—Si—Al-based alloy, an Fe—Si—B—P—Cu—C-based alloy, an Fe—Si—B—Nb—Cu-based alloy, and the like. In addition, the metal magnetic particles 10a may contain impurities such as Cr, Mn, Cu, Ni, P, S, and Co that are unintended in manufacturing. In addition, although details will be explained in a description of a manufacturing method, the metal magnetic particles 10a may be contained in magnetic paste. Accordingly, an element (such as Cr, Al, Li, and Zn) more oxidizable than Fe to be added in the course of preparing the magnetic paste may be included in the metal magnetic particles.

Surfaces of the metal magnetic particles 10a made of the above-mentioned metal magnetic material may be covered with insulation coating (not shown). Insulation properties among the metal magnetic particles can be enhanced when the surfaces of the metal magnetic particles are covered with the insulation coating. A sol-gel method, a mechanochemical method, or the like can be used as a method of forming the insulation coating on the surfaces of the metal magnetic particles. A material for forming the insulation coating may be an oxide of P, Si, and the like. Alternatively, the insulation coating may be an oxide film formed by oxidizing the surfaces of the metal magnetic particles. A thickness of the insulation coating is preferably equal to or above 1 nm and equal to or below 50 nm (i.e., from 1 nm to 50 nm), more preferably equal to or above 1 nm and equal to or below 30 nm (i.e., from 1 nm to 30 nm), or even more preferably equal to or above 1 nm and equal to or below 20 nm (i.e., from 1 nm to 20 nm). For example, an image of a cross-section obtained by polishing a sample of the inductor may be captured with a scanning electron microscope (SEM), and the thickness of the insulation coating covering the surfaces of the metal magnetic particles can be measured from an SEM photograph thus obtained.

An average particle size of the metal magnetic particles 10a in the magnetic layer S is preferably equal to or above 1 μm and equal to or below 30 μm (i.e., from 1 μm to 30 μm), more preferably equal to or above 1 μm and equal to or below 20 μm (i.e., from 1 μm to 20 μm), or even more preferably equal to or above 1 μm and equal to or below 10 μm (i.e., from 1 μm to 10 μm). The average particle size of the metal magnetic particles 10a can be measured in accordance with the procedures described below. A sample cross-section is obtained by cutting a sample of the inductor. Specifically, a sample cross-section is obtained by cutting in such a way as to pass through a central part of the element body and to cross the mounting surface and the end surfaces of the element body at a right angle. Images of regions (130 μm×100 μm, for example) at multiple locations (five locations, for example) of the obtained cross-section are captured with the SEM, and the SEM images thus obtained are analyzed by using image analysis software (such as image analysis software Win ROOF 2021 (manufactured by Mitani Corporation)), thus obtaining equivalent circle diameters of the metal magnetic particles. An average value of the obtained equivalent circle diameters is defined as the average particle size of the metal magnetic particles.

A thermal treatment is conducted in the course of forming the element body 10. In this case, the metal magnetic particles 10a included in the element body 10 have an oxide film on their surfaces. This oxide film originates from the metal magnetic particles 10a and is formed by the thermal treatment. In the element body 10, the adjacent metal magnetic particles 10a are bonded to each other with the oxide film interposed therebetween.

The element body 10 may include a non-magnetic layer between the first coil 21 and the second coil 22. By providing the non-magnetic layer between the first coil 21 and second coil 22, it is possible to enhance insulation properties between the first coil 21 and the second coil 22, and to prevent a short circuit between the two coils.

The non-magnetic layer may include a glass ceramic material, a non-magnetic ferrite material, and the like as the non-magnetic materials. The non-magnetic layer may include the non-magnetic ferrite material as the non-magnetic material. As the non-magnetic ferrite material, it is possible to use a non-magnetic ferrite material having a composition in which Fe in terms of Fe₂O₃ is equal to or above 40 mol % and equal to or below 49.5 mol % (i.e., from 40 mol % to 49.5 mol %) on the basis of the entire non-magnetic layer, Cu in terms of CuO is equal to or above 6 mol % and equal to or below 12 mol % (i.e., from 6 mol % to 12 mol %) on the basis of the entire non-magnetic layer, and the remainder is ZnO. The non-magnetic material may contain Mn₃O₄, Co₃O₄, SnO₂, Bi₂O₃, SiO₂, and the like as additives when necessary, or may contain extremely small amounts of incidental impurities. The non-magnetic layer preferably contains Zn—Cu-based ferrite.

A thickness of the non-magnetic layer can be measured in accordance with the procedures described below. A sample of the inductor is vertically erected and is covered with a resin. In this instance, an LT surface is exposed. A cross-section parallel to the LT surface is exposed by completing polishing at a depth of about a half in the W direction of the sample by using a polishing machine. In order to eliminate sagging of internal conductors due to polishing, the polished surface after completion of the polishing is processed by ion milling (Ion Milling System IM4000 manufactured by Hitachi High-Tech Corporation). An image of a substantially central portion of the non-magnetic layer in the polished sample is captured with the SEM, a thickness of the substantially central portion of the non-magnetic layer is measured from an SEM photograph thus obtained, and this is defined as the thickness of the non-magnetic layer.

The element body 10 may include a non-magnetic portion between the first coil conductors 51 constituting the first coil 21 or between the second coil conductors 52 constituting the second coil 22. In this case, the non-magnetic portion is provided at at least one location between the adjacent coil conductors out of the first coil conductors 51 and the second coil conductors 52. By providing the non-magnetic portion between the adjacent coil conductors, it is possible to prevent a magnetic flux from leaking out between the coil conductors, and from causing reduction in inductance value.

The non-magnetic layer and the non-magnetic portion may have the same composition. For example, the non-magnetic layer and the non-magnetic portion may be formed from Zn—Cu-based ferrite.

The first coil 21 and the second coil 22 are provided inside the element body 10. The first coil 21 may be magnetically coupled to the second coil 22. For example, a coupling coefficient between the first coil 21 and the second coil 22 is equal to or above 0.1 and equal to or below 0.8 (i.e., from 0.1 to 0.8). Here, two coils including only the first coil 21 and the second coil 22 may be provided inside the element body 10, or three or more coils including the first coil 21 and the second coil 22 may be provided inside the element body 10.

### First Coil

The first coil 21 includes the multiple first coil conductors 51 in the direction of lamination (such as the height direction T). The adjacent first coil conductors 51 are connected to each other with the via conductor interposed therebetween. Here, the first coil 21 may include the first coil conductors 51 formed in the two different lamination groups and arranged in the direction of lamination, thus having a number of turns equal to 1.75. Note that the number of turns is not limited to 1.75, and may be equal to or above 2 by laminating the first coil conductors 51 in the direction of lamination.

Thicknesses of the respective first coil conductors 51 may be equal. In addition, the thickness of each first coil conductor 51 may be equivalent to a thickness of each second coil conductor 52 to be described later.

The first coil conductor 51 may be a metal conductor of Ag, Cu, and/or Pd, and the like as an example of the material thereof. The first coil conductor 51 may be formed by applying conductive paste to the above-described magnetic layer S, for example.

### Second Coil

The second coil 22 includes the multiple second coil conductors 52 in the direction of lamination (such as the height direction T). The adjacent second coil conductors 52 are connected to each other with the via conductor interposed therebetween. Here, the second coil 22 may include the second coil conductors 52 formed in the two different lamination groups and arranged in the direction of lamination, thus having a number of turns equal to 1.75. Note that the number of turns is not limited to 1.75 as in the illustrated example, and may be equal to or above 2 by laminating the first coil conductors 52 in the direction of lamination. In addition, the number of lamination of the second coil conductors 52 may be equal to or different from the number of lamination of the first coil conductors 51.

Thicknesses of the respective second coil conductors 52 may be equal. In addition, the thickness of each second coil conductor 52 may be equivalent to the thickness of each first coil conductor 51.

The second coil conductor 52 may be a metal conductor of Ag, Cu, and/or Pd, and the like as an example of the material thereof. In addition, the material of the second coil conductors 52 may adopt the material of the same type as that of the first coil conductor 51 or may adopt the material of a different type therefrom. The second coil conductor 52 may be formed by applying conductive paste to the above-described magnetic layer S, for example.

### Coil Conductor Connector

The coil conductor 50 includes the coil conductor connectors 50v. The coil conductor connectors 50v include the first coil conductor connector 51v, the second coil conductor connector 52v, the third coil conductor connector 53v, and the fourth coil conductor connector 54v. The first coil conductor connector 51v, the second coil conductor connector 52v, the third coil conductor connector 53v, and the fourth coil conductor connector 54v are provided inside the element body 10. Moreover, the first coil conductor connector 51v, the second coil conductor connector 52v, the third coil conductor connector 53v, and the fourth coil conductor connector 54v are exposed from the mounting surface (the first principal surface 11) of the element body 10.

Each coil conductor connector 50v may be a metal conductor of Ag, Cu, and/or Pd, and the like as an example of the material thereof. In addition, the material of the coil conductor connector 50v may adopt the material of the same type as that of the first coil conductor 51 and/or the second coil conductor 52 or may adopt the material of a different type therefrom. The coil conductor connector 50v may be formed by providing the above-described magnetic layer S with a through hole and applying conductive paste into the through hole, for example.

The first coil conductor connector 51v connects the end portion of the first coil conductor 51 out of the end portions of the first coil 21, which is located closest to the bottom surface (the first principal surface 11) of the element body 10, to the first external terminal 31. The first coil conductor connector 51v may extend along the direction of lamination (such as the height direction T). The first coil conductor connector 51v may have a multilayer structure.

The second coil conductor connector 52v connects the other end portion of the first coil 21 to the second external terminal 32. The second coil conductor connector 52v may extend along the direction of lamination (such as the height direction T). The second coil conductor connector 52v may have a multilayer structure.

The third coil conductor connector 53v connects the end portion of the second coil conductor 52 out of the end portions of the second coil 22, which is located closest to the bottom surface (the first principal surface 11) of the element body 10, to the third external terminal 33. The third coil conductor connector 53v may extend along the direction of lamination (such as the height direction T). The third coil conductor connector 53v may have a multilayer structure.

The fourth coil conductor connector 54v connects the other end portion of the second coil 22 to the fourth external terminal 34. The fourth coil conductor connector 54v may extend along the direction of lamination (such as the height direction T). The fourth coil conductor connector 54v may have a multilayer structure.

Here, in a preferred arrangement of the coil conductor connectors 50v, the second coil conductor connector 52v and the third coil conductor connector 53v to be electrically connected to an output electrode of the inductor 1 are arranged along one side constituting an outer edge of the element body 10. In other words, the second coil conductor connector 52v and the third coil conductor connector 53v are not arranged along a diagonal line of the element body 10 in plan view from the direction of lamination. By arranging the coil conductor connectors 50v as described above, it is possible to align the output electrode and an input electrode in the same direction.

### External Terminal

As shown in FIG. 2, the external terminals 30 include the first external terminal 31, the second external terminal 32, the third external terminal 33, and the fourth external terminal 34. The first external terminal 31 and the second external terminal 32 are provided on the first principal surface 11 of the element body 10 and are electrically connected to the first coil 21. The third external terminal 33 and the fourth external terminal 34 are provided on the first principal surface 11 of the element body 10 and are electrically connected to the second coil 22. In the inductor 1, the first principal surface 11 of the element body 10 can be defined as the mounting surface.

The first external terminal 31 acts as an input electrode for the first coil 21. The first external terminal 31 may be provided only to the first principal surface 11 of the element body 10, or may be provided across the first principal surface 11 of the element body 10 and at least one of the first end surface 13 and the second side surface 16.

The second external terminal 32 acts as an output electrode for the first coil 21. The second external terminal 32 may be provided only to the first principal surface 11 of the element body 10, or may be provided across the first principal surface 11 of the element body 10 and at least one of the second end surface 14 and the second side surface 16.

The third external terminal 33 acts as an output electrode for the second coil 22. The third external terminal 33 may be provided only to the first principal surface 11 of the element body 10, or may be provided across the first principal surface 11 of the element body 10 and at least one of the second end surface 14 and the first side surface 15.

The fourth external terminal 34 acts as an input electrode for the second coil 22. The fourth external terminal 34 may be provided only to the first principal surface 11 of the element body 10, or may be provided across the first principal surface 11 of the element body 10 and at least one of the first end surface 13 and the first side surface 15.

Each external terminal 30 includes a coil conductor connection region CL located on an exposed region where the coil conductor 50 is exposed from the element body (a region where the coil conductor connector 50v is exposed) in see-through plan view from the mounting surface side of the element body 10, and an overlap region OL overlapping the element body 10. In other words, the plane area of the external terminal 30 is larger than the plane area of the coil conductor connector 50v in see-through plan view from the mounting surface side of the element body 10. By setting the plane area of the external terminal 30 relatively larger, electrodes on a mounting substrate and the external terminals 30 of the inductor 1 can easily be aligned when mounting the inductor 1 on the mounting substrate and the like.

The external terminal 30 may use various materials such as Cu and Ni, for example. In addition, the external terminal 30 may be formed from a single layer or may have a multilayer structure including two or more layers. Although the external terminal 30 may be formed in accordance with any methods, the external terminal 30 may be formed by plating (such as electroless plating), for instance. In the case of forming the external terminal 30 by plating, a plating formation mechanism to be applied to the coil conductor connector 50v is different from a plating formation mechanism to be applied to the element body 10 containing the metal magnetic particles 10a. For this reason, in the inductor 1 according to the present embodiment, an average length of contact of the metal magnetic particles 10a with the external terminal 30 relative to a length of the overlap region OL of the external terminal 30 in a cross-section taken from the mounting surface (the first principal surface 11) side of the element body 10 in the height direction of the element body 10 along the length direction of the element body 10 at a position where the cross-section passes through the external terminal 30 is equal to or below 10%, preferably equal to or below 8%, more preferably equal to or below 4%, or even more preferably equal to 0% (see FIG. 4). Note that a method of calculating the “average length of contact of the metal magnetic particles with the external terminal” as described in the present specification will be discussed in detail in the example to be described later.

Now, a specific plating formation mechanism will be described in detail. In the case of forming the metal magnetic particles 10a from Fe, the coil conductor connectors 50v from Ag, and the external terminals 30 from Cu, for example, the ionization tendency of the metal magnetic particles (Fe) is larger than the ionization tendency of the coil conductor connectors (Ag), and a plating growth reaction is preferentially started on the metal magnetic particle side having the larger ionization tendency. Accordingly, the traditional “inductor in which the external terminal is in contact with the element body containing the metal magnetic powder, and the plane area of the external terminal is larger than the plane area of the coil conductor connector in see-through plan view from the mounting surface side of the element body 10” would cause plating growth attributed to the metal magnetic particles, thereby developing abnormal formation of the external terminals.

On the other hand, according to the inductor 1 of the present embodiment, the average length of contact of the metal magnetic particles 10a with the external terminals 30 is equal to or below 10% relative to the length of the overlap region OL (see FIG. 4), so that the plating growth attributed to the metal magnetic particles 10a can be reduced. As a consequence, it is possible to reduce abnormal formation of the external terminals 30.

An example of a method of rendering the average length of contact of the metal magnetic particles 10a with the external terminals 30 equal to or below 10% relative to the length of the overlap region OL may be realized by removing the metal magnetic particles 10a from the mounting surface (the first principal surface 11) of the element body 10. According to this configuration, since the metal magnetic particles 10a have been removed from the mounting surface of the element body 10, it is possible to further reduce a percentage of the metal magnetic particles 10a on the mounting surface and further to reduce the chance of contact of the metal magnetic particles 10a with the external terminals 30.

In addition, particle removal of the metal magnetic particles 10a is not limited to the mounting surface of the element body 10, and the metal magnetic particles 10a may also be removed from the surfaces (such as the second principal surface 12, the first end surface 13, the second end surface 14, the first side surface 15, and/or second side surface 16) other than the mounting surface of the element body 10. According to the above-described configuration, since the unintended metal magnetic particles 10a around the element body 10 are removed, it is possible to reduce the plating formation that would grow due to these metal magnetic particles 10a.

Concerning the particle removal of the metal magnetic particles 10a, surface roughness of the mounting surface (the first principal surface 11) of the element body 10 is greater than surface roughness of a surface (the second principal surface 12) on the opposite side of the mounting surface of the element body 10. In the present specification, the surface roughness can be measured in accordance with the following method.

(1) A cross-section taken in parallel to the height direction T (see FIG. 1) of the element body 10 from the mounting surface side is formed along an imaginary line that passes through the external terminal and the coil conductor connection region on the mounting surface of the element body 10 and extends in the length direction L of the element body. Such cross-sections are formed at three locations along the width direction W (see FIG. 1) of the element body.

(2) Regarding each of those cross-sections, images are captured at three image capture positions in total, namely, the center and two ends of the external terminal having a longer distance from the coil conductor connection region to a tip end out of portions on two sides of the coil conductor connection region of the external terminal 30 on the first principal surface of the element body 10 which extend outward from the coil conductor connection region and come into contact with the element body 10, as well as three image capture positions on the second principal surface 12 of the element body 10 corresponding to the aforementioned image capture positions, at 5000-fold magnification with an SEM (name of manufacturer: JEOL Ltd., Schottky field emission scanning electron microscope, model number: JSM-7900F) and an EDX (name of manufacturer: JEOL Ltd., Schottky field emission scanning electron microscope, model number: JSM-7900F).

(3) Regarding the field of view of each captured image, positional relations of the metal magnetic particles in the SEM can be confirmed by checking positions of a composition (such as Fe) of the metal magnetic particles 10a contained in the element body 10 and a composition (such as Cu) of the external terminals 30 by the EDX.

Next, the SEM image is loaded into the image analysis software “Win Roof” (manufactured by Mitani Corporation) so as to identify outer edges on the element body surface side of the metal magnetic particles in the SEM image based on a composition image (such as an Fe composition image) of the metal magnetic particles of the EDX.

Then, a tangent line is drawn between the outer edge of the metal magnetic particle among the outer edges of the metal magnetic particles in the field of view of the captured image, which is the first to be located on the element surface side, with the outer edge of the metal magnetic particle which is the second to be located on the element surface side, and a distance is measured between the tangent line and the outer edge of the metal magnetic particle among the outer edges of the metal magnetic particles which is the first to be recessed to an inner side of the element body. It is possible to measure surface roughness of the first principal surface 11 and surface roughness of the second principal surface 12 (maximum irregularity) by carrying out this measurement on the first principal surface 11 and the second principal surface 12 of the element body 10.

As a preferred form of the external terminal 30, the external terminal 30 may extend into recesses formed in the mounting surface (the first principal surface 11) of the element body 10 by removing the metal magnetic particles 10a. According to the above-described configuration, the external terminals 30 extending into the recesses formed by removing the metal magnetic particles 10a bring about an anchoring effect. Thus, it is possible to enhance the adhesion between the element body 10 and the external terminal 30.

### Insulating Layer

The insulating layer 70 covers the surface of the mounting surface (the first principal surface 11) of the element body 10 except the external terminals 30. Specifically, the insulating layer 70 is a layer to be laminated on the first principal surface 11 of the element body 10 (see FIGS. 1 to 4), and a photoresist is cited as an example thereof. By providing the inductor 1 of the present embodiment with the insulating layer 70 as described above, it is possible to prevent a short circuit between the inductor 1 and the mounting substrate that mounts the inductor 1.

In addition, as a preferred form of the insulating layer 70, the insulating layer 70 may extend into recesses formed in the mounting surface (the first principal surface 11) of the element body 10 by removing the metal magnetic particles 10a (see FIG. 4). According to the above-described configuration, the insulating layer 70 extending into the recesses formed by removing the metal magnetic particles 10a brings about an anchoring effect. Thus, it is possible to enhance the adhesion between the element body 10 and the insulating layer 70.

### Inductor of Second Embodiment

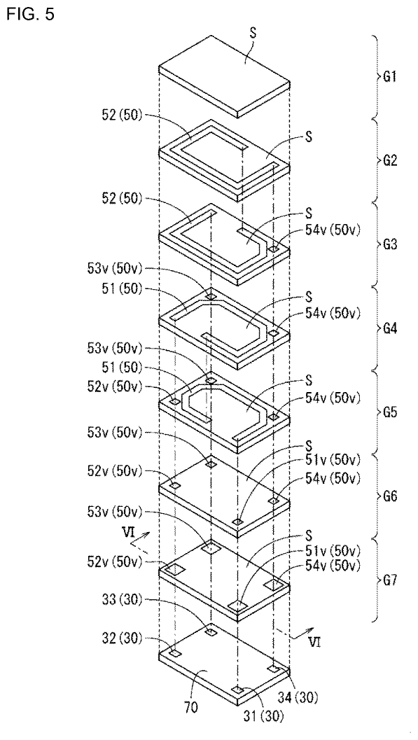

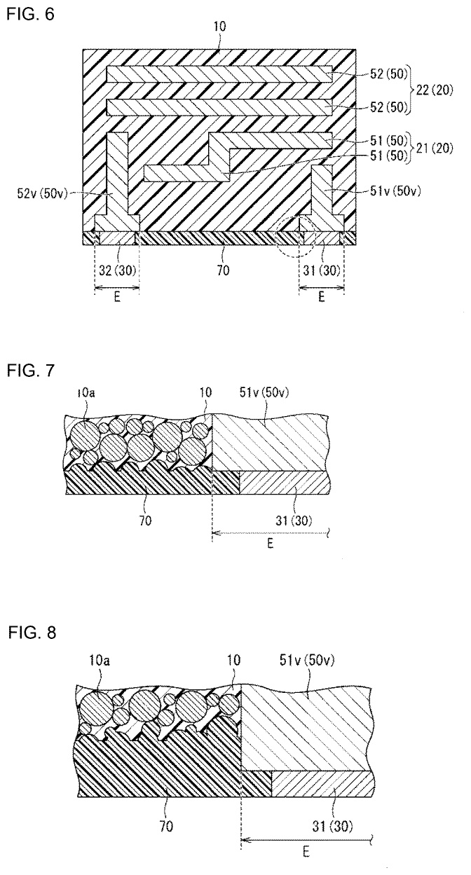

Next, an inductor of a second embodiment will be described with reference to FIGS. 5 to 8. FIG. 5 is an exploded perspective view of the inductor of the second embodiment. FIG. 6 is a cross-sectional view in a direction of arrows which is taken along line VI-VI in FIG. 5. FIG. 7 is an enlarged cross-sectional view of a principal part in FIG. 6. FIG. 8 is an enlarged cross-sectional view of a principal part of an inductor according to a modification of the second embodiment. The inductor of the second embodiment has a configuration concerning the external terminal which is different from that of the inductor of the above-described first embodiment. In the following explanations, features that are different from those of the above-described embodiment will mainly be discussed.

The inductor 1 of the present embodiment includes the element body 10 including the coil conductors 50 inside and containing the metal magnetic particles 10a, the coil conductor connectors 50v electrically connected to the coil conductors 50 and exposed from the element body 10, and the external terminals 30 provided at the mounting surface (the first principal surface 11) of the element body 10 and electrically connected to the coil conductor connectors 50v. Moreover, in see-through plan view from the mounting surface side of the element body 10, each external terminal 30 is disposed on an inner side of an exposed region E where the coil conductor connector 50v is exposed from the element body 10 (see FIG. 6 and FIG. 7).

More specifically, unlike the first embodiment, the inductor 1 of the present embodiment has the plane area of the external terminal 30 in see-through plan view from the mounting surface side of the element body 10, which is smaller than the plane area of the coil conductor connector 50v. In other words, in see-through plan view from the mounting surface side of the element body 10, no overlap regions OL where the external terminals 30 overlap the element body 10 are provided. However, in light of having the technical idea of “not causing plating growth attributed to the metal magnetic particles contained in the element body”, the inductor of the first embodiment and the inductor of the second embodiment possess the technical idea in common.

That is to say, in the inductor 1 of the second embodiment, each external terminal 30 is disposed on the inner side of the exposed region E where the coil conductor connector 50v is exposed from the element body 10 in see-through plan view from the mounting surface side of the element body 10, and the element body 10 is not brought into contact with the external terminal 30. Accordingly, even when the external terminal 30 is formed by plating, it is possible to reduce abnormal formation of the external terminal 30.

As a preferred embodiment of the inductor, a depth of recesses formed by removing the metal magnetic particles 10a may be equal to or above a maximum particle size of the metal magnetic particles 10a and equal to or below twice the maximum particle size of the metal magnetic particles 10a. Here, a method of measuring the maximum particle size adopts the method explained in conjunction with <Inductor of first embodiment>. Specifically, a sample cross-section is obtained by cutting in such a way as to pass through a central part of the element body and to cross the mounting surface and the end surfaces of the element body at a right angle. Images of regions (130 μm×100 μm, for example) at multiple locations (five locations, for example) of the obtained cross-section are captured with the SEM, and the obtained SEM images are analyzed by using the image analysis software (such as the image analysis software Win ROOF 2021 (manufactured by Mitani Corporation)), thus obtaining the equivalent circle diameters of the metal magnetic particles. The maximum value of the obtained equivalent circle diameters is defined as the maximum value of the particle sizes of the metal magnetic particles. According to the above-described configuration, it is possible to ensure the thickness of the insulating layer 70 so that strength of the inductor can be increased. Here, the specification concerning the depth of the recesses obtained by particle removal may also be applied to the inductor according to the first embodiment.

### Method of Manufacturing Inductor of First Embodiment

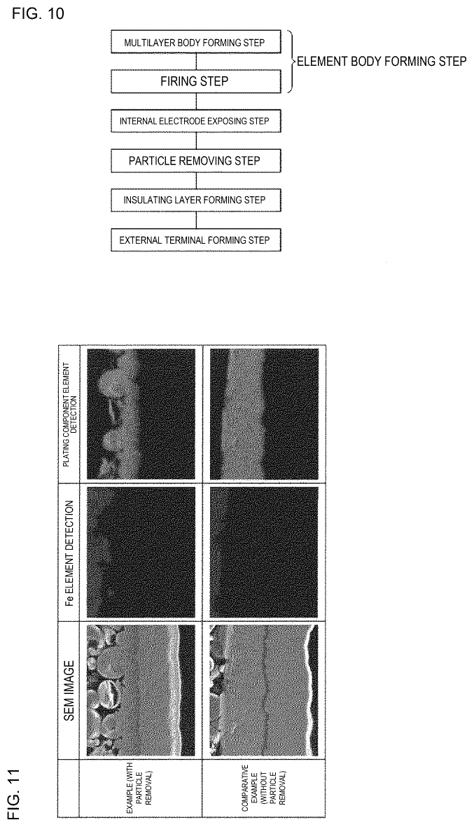

A method of manufacturing the “inductor of the first embodiment” will be described with reference to FIG. 10. FIG. 10 is a flowchart showing the method of manufacturing an inductor of the present disclosure. The method of manufacturing the inductor of the first embodiment includes an element body forming step, an exposing step, a particle removing step, an external terminal forming step, and an insulating layer forming step. The steps will be described in detail below.

### Element Body Forming Step

The element body forming step includes a multilayer body forming step of forming a multilayer body constituting the element body 10, and a firing step of firing the multilayer body.

### Multilayer Body Forming Step

The magnetic layers S described with reference to FIG. 2 are prepared first. The magnetic layers S are prepared by applying and overlapping magnetic paste containing metal magnetic particles 10a preferably having an average particle size equal to or above 1 μm and equal to or below 30 μm (i.e., from 1 μm to 30 μm), more preferably equal to or above 1 μm and equal to or below 20 μm (i.e., from 1 μm to 20 μm), or even more preferably equal to or above 1 μm and equal to or below 10 μm (i.e., from 1 μm to 10 μm).

Next, the conductive paste serving as the coil conductors 50 is applied onto the prepared magnetic layers S, the conductive paste serving as the conductive layers (or the via conductors) to connect the coil conductors 50 to one another is applied, the conductive paste serving as the coil conductor connectors 50v is applied, and then the magnetic paste is applied to portions other than the coil conductors, the conductive layers, and the coil conductor connectors. Thus, the lamination groups G1 to G7 described with reference to FIG. 2 are prepared. Thereafter, the multilayer body is formed by laminating and pressure-bonding the prepared lamination groups G1 to G7.

### Firing Step

The formed multilayer body is subjected to debinding so as to remove binder contained in the magnetic paste and the conductive paste and then to firing. A firing temperature is a temperature adequate for baking the multilayer body and may be about 700° C., for example. Moreover, the multilayer body is impregnated with a resin and curing is carried out in order to increase the strength of the multilayer body. While epoxy resin is used as the resin with which the multilayer body is impregnated, one or more types of resins selected from the group consisting of phenol resin, polyester resin, polyimide resin, polyolefin resin, silicone resin, acrylic resin, polyvinyl butyral resin, cellulose resin, alkyd resin, and the like may be used. The element body 10 including the coil conductors 50 inside and containing the metal magnetic particles 10a and the resin is formed by carrying out the above-described steps.

### Exposing Step

The exposing step is a step of exposing the coil conductor connectors 50v, which are electrically connected to the coil conductors 50, from the element body 10. Specifically, the coil conductor connectors 50v are exposed from the element body 10 by subjecting the first principal surface 11 of the element body 10 to grinding, thereby ensuring electrical connectivity to the external terminals 30 to be described later. That is to say, the coil conductor connectors 50v are exposed on the mounting surface side of the multilayer body by removing the above-mentioned resin impregnating the multilayer body. Note that grinding may be carried out on the second principal surface 12, the first end surface 13, the second end surface 14, the first side surface 15, and/or the second side surface 16 of the element body 10 in order to adjust the shape of the element body 10. Here, the exposing step is not limited to the technique using grinding but any technique may be employed as long as such a technique can expose the coil conductor connectors 50v from the element body 10. For example, the coil conductor connectors 50v may be exposed from the element body 10 by subjecting the element body 10 to chemical etching.

### Particle Removing Step

The particle removing step is a step of removing the metal magnetic particles 10a from the mounting surface (the first principal surface 11) of the element body 10. Specifically, the metal magnetic particles 10a are remove from the mounting surface (the first principal surface 11) of the element body 10 by immersing the element body 10 including the metal magnetic particles 10a into an acidic solution. Sulfuric acid is cited as an example of the acidic solution to remove the metal magnetic particles 10a. Here, after the metal magnetic particles 10a are removed by immersion into the acidic solution, a thin resin film may be formed or an oxide coating may be formed by an oxidation treatment at the relevant location.

### Insulating Film Forming Step

The insulating film forming step is a step of forming the insulating layer 70 on the mounting surface (the first principal surface 11) of the element body 10 at least except positions where the coil conductor connectors 50v are exposed from the element body 10. Specifically, the insulating layer 70 may be formed from a photoresist resin having photosensitivity and containing silica as filler, for example. The photoresist resin is applied to the entire mounting surface of the element body 10 by screen printing or the like. The photosensitive photoresist resin applied to the entire mounting surface is subjected to pattern exposure in accordance with the shapes of the external terminals 30 to be described later, and then the insulating layer 70 at the locations to form the external terminals 30 is removed by dipping the insulating layer 70 in a developer. Here, in the case of manufacturing the inductor of the first embodiment, the insulating layer 70 is formed such that each external terminal 30 has the overlap region that overlaps the element body 10 in see-through plan view from the mounting surface side of the element body 10. Note that although the technique using the photoresist resin having photosensitivity has been described in the above-mentioned insulating film forming step, a photoresist film may be attached to the mounting surface of the element body 10 as a technique of forming the insulating layer other than screen printing.

### External Terminal Forming Step

The external terminal forming step is a step of forming the external terminals at the particle removal locations where the metal magnetic particles have been removed and the locations where the coil conductor connectors are exposed from the element body. Specifically, a Pd catalyst is provided for the regions on the mounting surface (the first principal surface 11) of the element body 10 where the insulating layer 70 has been removed, and the external terminals are formed by electroless plating. As for the plating composition, Cu plating is formed on the coil conductor connectors. Besides, other plating compositions include Ni—Sn, Ni—Au, Ni—Cu, Cu—Ni—Au, and the like. However, the plating compositions are not limited thereto. After formation of the external terminals, the inductor of the present embodiment can be manufactured by cutting into individual element pieces.

As described above, according to the method of manufacturing an inductor of the above-described present embodiment, the metal magnetic particles are removed from the mounting surface of the element body, and the external terminals are formed at the particle removal locations where the metal magnetic particles have been removed and the locations where the coil conductor connectors are exposed from the element body, so that the plating growth attributed to the metal magnetic particles can be reduced. As a consequence, it is possible to reduce abnormal formation of the external terminals.

### Method of Manufacturing Inductor of Second Embodiment

A method of manufacturing the “inductor of the second embodiment” will be described. In the method of manufacturing the inductor of the second embodiment, the element body forming step, the exposing step, and the particle removing step are substantially the same steps as those in the method of manufacturing the inductor of the first embodiment, and explanations will therefore be omitted. In the following description, different points from those of the above-mentioned method of manufacturing the inductor of the first embodiment will mainly be discussed.

### Insulating Layer Forming Step

In the insulating layer forming step of the method of manufacturing the inductor of the second embodiment, the insulating layer 70 is formed such that each external terminal 30 is disposed on the inner side of the exposed region E where the coil conductor connector 50v is exposed from the element body 10 in see-through plan view from the mounting surface side of the element body 10. In other words, the insulating layer 70 is formed in such a way as to cover part of the coil conductor connector 50v in see-through plan view from the mounting surface side of the element body 10.

### External Terminal Forming Step

In the external terminal forming step, each external terminal 30 is formed on the inner side of the exposed region E (see FIGS. 6 and 7) where the coil conductor connector 50v is exposed from the element body 10. In other words, the external terminal 30 is formed in such a way as to come into contact only with the coil conductor connector 50v without coming into contact with the element body 10.

As described above, in the method of manufacturing the inductor explained in the present embodiment, each external terminal 30 is disposed on the inner side of the exposed region E where the coil conductor connector 50v is exposed from the element body 10 in see-through plan view from the mounting surface side of the element body 10, and the element body 10 is not in contact with the external terminal 30. Accordingly, even when the external terminal 30 is formed by plating, it is possible to reduce abnormal formation of the external terminal 30.

### EXAMPLE

Verification tests concerning the inductor of the present disclosure will be described in detail.

### Verification Test 1: Composition Analysis

A composition analysis by the EDX was carried out on an example and a comparative example shown below:

### Example

The inductor of the first embodiment shown in FIG. 4 subjected to the particle removing step shown in FIG. 10; and

### Comparative Example

An inductor not subjected to the particle removing step shown in FIG. 10.

The composition analysis by the EDX was carried out by using the EDX (name of manufacturer: JEOL Ltd., model number: JSM-7900F). As for an observation condition, the composition analysis was conducted at 5000-fold observation magnification.

Results of the composition analysis are shown in FIG. 11. The results of composition analysis of FIG. 11 successfully confirmed that, in the inductor of the example, Fe element was detected at the positions where the metal magnetic particles were contained in the element body and an element (such as Cu element) constituting the plating component as the external terminals extended into recesses formed by removing the particles in the element body. On the other hand, the results successfully confirmed that, in the inductor of the comparative example, there was a clear boundary between Fe element as the metal magnetic particles and the element (such as Cu element) constituting the plating component as the external terminals, and the external terminals therefore did not extend into the element body.

### Verification Test 2: SEM Observation 1

The inductor of the example and the inductor of the comparative example described above were subjected to SEM observation. The SEM observation was carried out by using the SEM (name of manufacturer: JEOL Ltd., model number: JSM-7900F). As for observation conditions, the SEM observation was conducted under two conditions of observation magnifications at 1500-fold magnification and 5000-fold magnification.

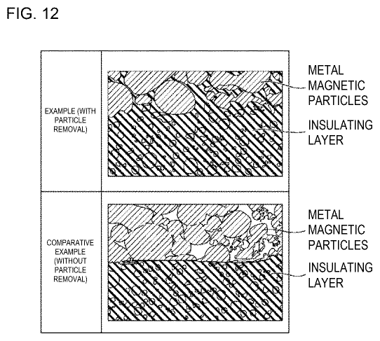

FIG. 12 shows schematic diagrams of SEM images. Here, the schematic diagrams shown in FIG. 12 depict positions in the vicinity of the boundary between the element body containing the metal magnetic particles and the insulating layer. FIG. 12 successfully confirmed that the insulating layer of the inductor of the example extended into the recesses formed by removing the metal magnetic particles. In particular, the state of the insulating layer apparently extending into the element body was successfully confirmed by increasing the magnification up to 5000 times. On the other hand, there was a clear boundary between the insulating layer and the element body in the inductor of the comparative example and the insulating layer did not extend into the element body.

### Verification Test 3: SEM Observation 2

In the verification test 3, the example and the comparative example were subjected to SEM observation in light of the presence and absence of abnormal plating growth. The SEM observation was conducted under an observation condition at about 500-fold magnification.

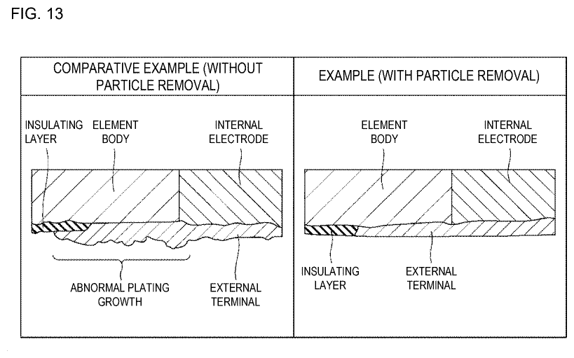

FIG. 13 shows schematic diagrams of SEM images. In the inductor of the comparative example, an average length of contact of the metal magnetic particles with the external terminals relative to the length of the overlap region exceeds 10%. Accordingly, the metal magnetic particles 10a exposed to the surface of the element body have a large impact. Since the plating formation mechanism to be applied to the element body 10 containing the metal magnetic particles 10a is different from the plating formation mechanism to be applied to the coil conductor connector 50v, abnormal plating growth occurs on the element body side of the external terminal. The “abnormal plating growth” referred to in the present specification intends a situation where an average thickness of plating thicknesses on the element body is larger by at least 20% than an average thickness of plating thicknesses on the coil conductor connection region. On the other hand, in the inductor of the example, the average length of contact of the metal magnetic particles with the external terminals in the overlap region where the external terminals overlap the element body in see-through plan view from the mounting surface side of the element body is equal to or below 10% of the length of the overlap region, which will be described later in the verification test 4. Thus, the absence of abnormal plating growth as in the inductor of the comparative example was successfully confirmed.

### Verification Test 4: SEM Observation 3

In the verification test 4, contact percentages of the metal magnetic particles with the external terminal for the example were calculated based on SEM observation. A method of calculation will be described below in detail.

(1) A cross-section taken in parallel to the height direction T (see FIG. 1) of the element body 10 from the mounting surface side (the first principal surface 11 side) is formed along the imaginary line that passes through the external terminal and the coil conductor connection region on the mounting surface of the element body 10 and extends in the length direction L of the element body. Such cross-sections are formed at three locations along the width direction W (see FIG. 1) of the element body.

(2) Regarding each of the cross-sections and concerning each of the external terminals 30 on the first principal surface of the element body 10, images are captured at three image capture positions in total, namely, the center and two ends of the external terminal having a longer distance from the coil conductor connection region to a tip end out of portions on two sides of the coil conductor connection region of the external terminal 30 which extend outward from the coil conductor connection region and come into contact with the element body 10, at 5000-fold magnification with the SEM (name of manufacturer: JEOL Ltd., model number: JSM-7900F) and the EDX (name of manufacturer: JEOL Ltd., model number: JSM-7900F).

(3) Regarding the field of view of each captured image, positional relations of the metal magnetic particles, the element body, and the external terminals are confirmed by checking positions of a composition (such as Fe) of the metal magnetic particles 10a constituting the element body 10, a composition (such as C) of the resin in the element body, and a composition (Cu) of the external terminals by the EDX.

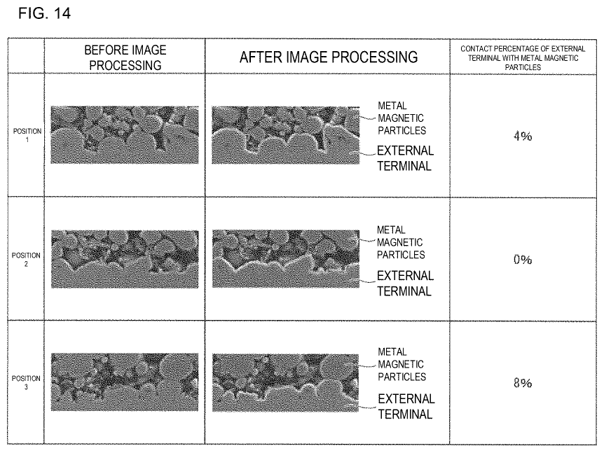

Next, the SEM image is loaded into the image analysis software “Win Roof” (manufactured by Mitani Corporation) so as to identify outer edges of the external terminals in the SEM image based on a composition image (such as a Cu composition image) of the external terminals of the EDX (see SEM photographs after image processing in FIG. 14). Then, lengths of the outer edges on the metal magnetic particle side of the external terminals are calculated by image processing.

Next, based on a composition image (such as an Fe composition image) of the metal magnetic particles and on a composition image (such as a C composition image) of the resin of the EDX, the outer edges of the metal magnetic particles satisfying the conditions that no resin is present around the metal magnetic particles and that the metal magnetic particles are in contact with the external terminals are identified by the image processing.

Then, percentages of a contact length of the metal magnetic particles in contact with the external terminal relative to a length of the outer edge on the metal magnetic particle side of the external terminal are calculated for the fields of view of the multiple captured images for the respective external terminals, and an average thereof is calculated for all of the external terminals as contact percentages shown in FIG. 14.

Results of calculation of the contact percentages of the metal magnetic particles with the external terminal are shown in FIG. 14. The results confirmed that the contact percentage was equal to or below 10% at any of the three image capture locations in the width direction of the element body (position 1: 4%, position 2: 0%, position 3: 8%). Moreover, no abnormal plating growth explained in the verification test 3 was confirmed at any of the three locations.

As described above, according to the inductor and the method of manufacturing the inductor of the present disclosure, it is possible to reduce abnormal formation of the external terminals and to improve yields of the inductors.

Note that the embodiments disclosed herein are merely illustrative in all aspects and do not provide a basis for limited interpretation. For example, the above-described embodiments have disclosed the coil formed by laminating the coil conductors. However, the coil is not limited to this configuration and the coil may be formed by winding a conductive wire. More specifically, an air-core coil formed by winding a conductive wire helically in two stages such that extended portions at the beginning and the end of the conductive wire are located on an outer periphery may be buried in such a way that a winding axis is perpendicular to the mounting surface of the element body.

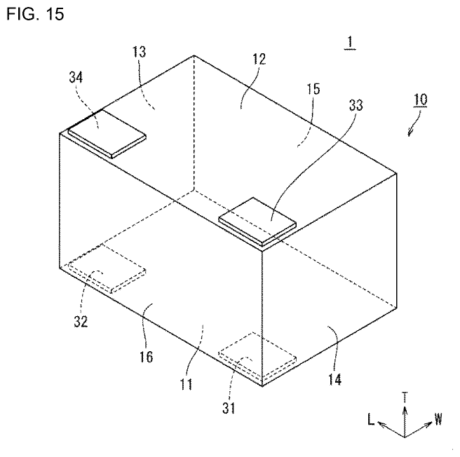

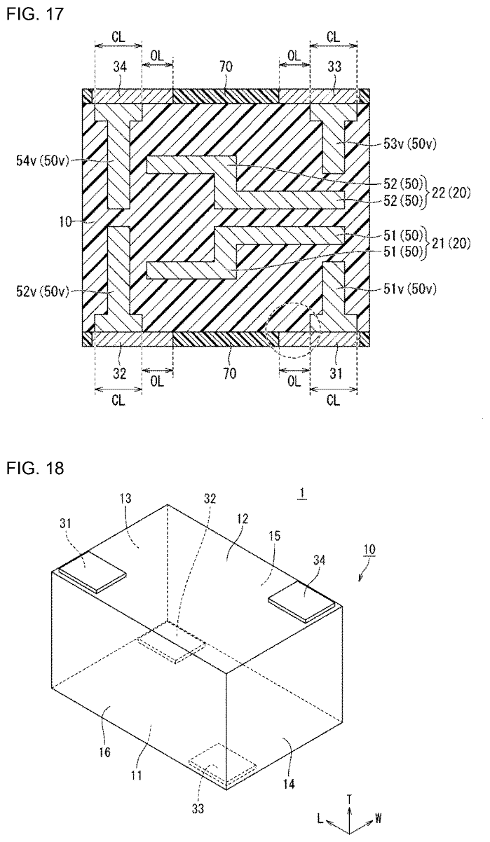

In addition, the inductor of the first embodiment and the inductor of the second embodiment may instead adopt the forms of the element body 10 and the external terminals 30 as shown in FIGS. 15 to 17. The forms of the element body 10 and the external terminals 30 will be described below in detail.

### Element Body

In the element body 10 shown in FIG. 15, the third external terminal 33 electrically connected to one end of the second coil 22 and the fourth external terminal 34 electrically connected to the other end of the second coil 22 are disposed on the second principal surface 12. In addition, the third external terminal 33 and the fourth external terminal 34 are arranged along a long side (or a short side) of the second principal surface 12.

Moreover, in the element body 10 shown in FIG. 15, the first external terminal 31 electrically connected to one end of the first coil 21 and the second external terminal 32 electrically connected to the other end of the first coil 21 are disposed on the first principal surface 11. In addition, the first external terminal 31 and the second external terminal 32 are arranged along a long side (or a short side) of the first principal surface 11.

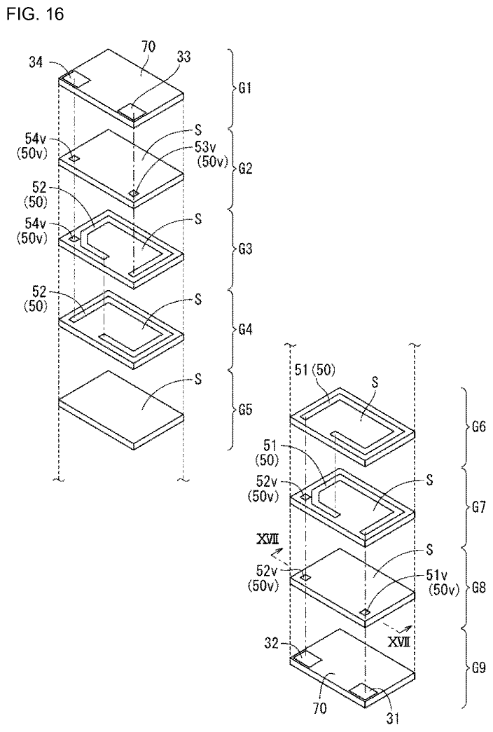

The element body 10 shown in FIG. 15 may be formed by laminating lamination groups G1 to G9 shown in FIG. 16. While the lamination groups G1 to G9 will be described below in detail, constituents common to those in FIG. 2 described above will be denoted by the same reference signs and explanations thereof will be omitted as appropriate.

The lamination group G1 constitutes the second principal surface 12 of the element body 10. Moreover, the third external terminal 33 and the fourth external terminal 34 are arranged along the long side (or the short side) of the second principal surface 12.

In the lamination group G2, the third coil conductor connector 53v and the fourth coil conductor connector 54v are disposed so as to correspond to the arrangement of the third external terminal 33 and the fourth external terminal 34.

The second coil conductors 52 are disposed such that the second coil 22 is formed by the lamination group G3 and the lamination group G4.

In the lamination group G5, the magnetic layer S is disposed in order to electrically insulate the first coil 21 from the second coil 22.

The first coil conductors 51 are disposed such that the first coil 21 is formed by the lamination group G6 and the lamination group G7.

In the lamination group G8, the first coil conductor connector 51v and the second coil conductor connector 52v are disposed so as to correspond to the arrangement of the first external terminal 31 and the second external terminal 32.

The lamination group G9 constitutes the first principal surface 11 of the element body 10. Moreover, the first external terminal 31 and the fourth external terminal 32 are arranged along the long side (or the short side) of the first principal surface 11.

In addition, the insulating layer 70 covers surfaces of the mounting surfaces (the first principal surface 11 and the second principal surface 12) of the element body 10 except the external terminals 30.

In the above-mentioned inductor as well, an average length of contact of the metal magnetic particles 10a with the external terminal 30 relative to a length of the overlap region OL of the external terminal 30 in the cross-section taken in the height direction of the element body 10 along the length direction of the element body 10 at the position where the cross-section passes through the external terminal 30 and the coil conductor connection region CL from the mounting surface (the first principal surface 11 and/or second principal surface 12) side of the element body 10 is equal to or below 10% as described in conjunction with the inductor of the first embodiment. Accordingly, it is possible to reduce the plating growth attributed to the metal magnetic particles, and to reduce abnormal formation of the external terminals.

Here, regarding the above-mentioned inductor, each external terminal may be disposed on the inner side of the exposed region where the coil conductor connector is exposed from the element body in see-through plan view from the mounting surface side of the element body as described in conjunction with the inductor of the second embodiment. The inductor of the second embodiment as described above can prevent the metal magnetic particles from coming into contact with the external terminal, thus reducing abnormal formation of the external terminal.

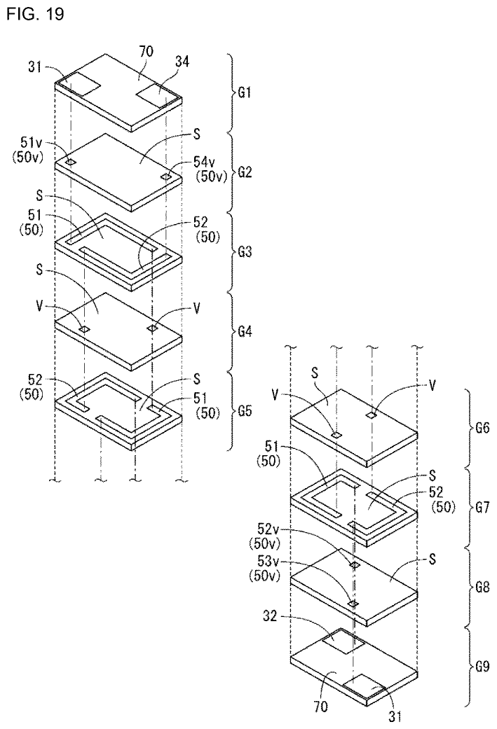

In addition, the inductor of the first embodiment and the inductor of the second embodiment may instead adopt the forms of the element body 10 and the external terminal 30 as shown in FIGS. 18 and 19. The forms of the element body 10 and the external terminal 30 will be described below in detail.

### Element Body

In the element body 10 shown in FIG. 18, the first external terminal 31 electrically connected to one end of the first coil 21 and the fourth external terminal 34 electrically connected to one end of the second coil 22 are disposed on the second principal surface 12. In addition, the first external terminal 31 and the fourth external terminal 34 are arranged on a diagonal line of the second principal surface 12.

Moreover, in the element body 10 shown in FIG. 18, the second external terminal 32 electrically connected to the other end of the first coil 21 and the third external terminal 33 electrically connected to the other end of the second coil 22 are disposed on the first principal surface 11. In addition, the second external terminal 32 and the third external terminal 33 are arranged on a diagonal line of the first principal surface 11 (a diagonal line different from the diagonal line of the second principal surface 12).

The element body 10 shown in FIG. 18 may be formed by laminating lamination groups G1 to G9 shown in FIG. 19. While the lamination groups G1 to G9 will be described below in detail, constituents common to those in FIG. 2 or FIG. 16 described above will be denoted by the same reference signs and explanations thereof will be omitted as appropriate.

The lamination group G1 constitutes the second principal surface 12 of the element body 10. Moreover, the first external terminal 31 and the fourth external terminal 34 are arranged on the diagonal line of the second principal surface 12.

In the lamination group G2, the first coil conductor connector 51v and the fourth coil conductor connector 54v are disposed so as to correspond to the arrangement of the first external terminal 31 and the fourth external terminal 34.

The first coil conductors 51 are disposed in the lamination group G3, the lamination group G5, and a portion of the lamination group G7 in such a way as to form the first coil 21. More specifically, the first coil conductor 51 is disposed along two sides of the magnetic layer S constituting the corner portion corresponding to the second external terminal 32 in see-through plan view in the lamination group G3, the first coil conductor 51 is disposed along three sides of the continuous magnetic layer S including the corner portion corresponding to the third external terminal 33 and the corner portion corresponding to the fourth external terminal 34 in see-through plan view in the lamination group G5, and the first coil conductor 51 is disposed along three sides of the continuous magnetic layer S including the corner portion corresponding to the first external terminal 31 and the corner portion corresponding to the second external terminal 32 in see-through plan view in the lamination group G7. The respective first coil conductors 51 are electrically connected to one another by using via conductors V.

Moreover, the second coil conductors 52 are disposed in the lamination group G3, the lamination group G5, and a portion of the lamination group G7 in such a way as to form the second coil 22. More specifically, the second coil conductor 52 is disposed along two sides of the magnetic layer S constituting the corner portion corresponding to the third external terminal 33 in see-through plan view in the lamination group G3, the second coil conductor 52 is disposed along three sides of the continuous magnetic layer S including the corner portion corresponding to the first external terminal 31 and the corner portion corresponding to the second external terminal 32 in see-through plan view in the lamination group G5, and the second coil conductor 52 is disposed along three sides of the continuous magnetic layer S including the corner portion corresponding to the third external terminal 33 and the corner portion corresponding to the fourth external terminal 34 in see-through plan view in the lamination group G7. The respective second coil conductors 52 are electrically connected to one another by using via conductors V.

To put it another way, the first coil conductors 51 and the second coil conductors 52 may be arranged in a point-symmetric relation with respect to the centers of the lamination groups G3, G5, and G7 as an axis.

In the lamination group G8, the second coil conductor connector 52v and the third coil conductor connector 53v are disposed so as to correspond to the arrangement of the second external terminal 32 and the third external terminal 33.

The lamination group G9 constitutes the first principal surface 11 of the element body 10. Moreover, the second external terminal 32 and the third external terminal 33 are arranged on the diagonal line of the first principal surface 11.

In addition, the insulating layer 70 covers the surfaces of the mounting surfaces (the first principal surface 11 and the second principal surface 12) of the element body 10 except the external terminals 30.

In the above-mentioned inductor as well, the average length of contact of the metal magnetic particles 10a with the external terminal 30 relative to the length of the overlap region OL of the external terminal 30 in the cross-section taken in the height direction of the element body 10 along the length direction of the element body 10 at the position where the cross-section passes through the external terminal 30 and the coil conductor connection region CL from the mounting surface (the first principal surface 11 and/or second principal surface 12) side of the element body 10 is equal to or below 10% as described in conjunction with the inductor of the first embodiment. Accordingly, it is possible to reduce the plating growth attributed to the metal magnetic particles, and to reduce abnormal formation of the external terminals.

Here, regarding the above-mentioned inductor, each external terminal may be disposed on the inner side of the exposed region where the coil conductor connector is exposed from the element body in see-through plan view from the mounting surface side of the element body as described in conjunction with the inductor of the second embodiment. The inductor of the second embodiment as described above can prevent the metal magnetic particles from coming into contact with the external terminal, thus reducing abnormal formation of the external terminal.

In addition, the technical scope of the present disclosure should not be interpreted only by the above-described embodiments but should be defined based on the claims. Moreover, the technical scope of the present disclosure encompasses all modifications that come within the meaning and range of equivalency of the claims.

The inductor and the method of manufacturing the inductor of the present disclosure encompass the following aspects.

<1> An inductor including an element body including a coil conductor inside and containing metal magnetic particles and a resin; and an external terminal provided at a mounting surface of the element body and electrically connected to the coil conductor. the element body includes a first principal surface and a second principal surface opposed to each other in a height direction, a first end surface and a second end surface opposed to each other in a length direction which orthogonal to the height direction, and a first side surface and a second side surface opposed to each other in a width direction orthogonal to the length direction and the height direction. the external terminal includes a coil conductor connection region located on an exposed region where the coil conductor is exposed from the element body in see-through plan view from the mounting surface side of the element body, and an overlap region overlapping the element body. An average length of contact of the metal magnetic particles with the external terminal relative to a length of the overlap region of the external terminal in a cross-section taken from the mounting surface side of the element body in the height direction of the element body along the length direction of the element body at a position where the cross-section passes through the external terminal and the coil conductor connection region is equal to or below 10%.

<2> An inductor including an element body including a coil conductor inside and containing metal magnetic particles and a resin; and an external terminal provided at a mounting surface of the element body and electrically connected to the coil conductor. The external terminal is disposed on an inner side of an exposed region where the coil conductor is exposed from the element body in see-through plan view from the mounting surface side of the element body.

<3> The inductor according to <1> or <2>, in which the metal magnetic particles have been removed from the mounting surface of the element body.

<4> The inductor according to any one of <1> to <3>, in which the metal magnetic particles have been removed from a surface of the element body other than the mounting surface.

<5> The inductor according to <3> or <4> as dependent on <1> but not dependent on <2>, in which the external terminal extends into recesses formed in the mounting surface of the element body by removing the metal magnetic particles.

<6> The inductor according to any one of <1> to <5>, in which the mounting surface of the element body is provided with an insulating layer covering a surface except a surface in contact with the external terminal.

<7> The inductor according to <6>, in which the insulating layer extends into recesses formed in the mounting surface of the element body by removing the metal magnetic particles.

<8>0 The inductor according to any one of <1> to <7>, in which a depth of recesses formed by removing the metal magnetic particles is equal to or above a maximum particle size of the metal magnetic particles and equal to or below twice the maximum particle size of the metal magnetic particles.

<9> A method of manufacturing an inductor, including an element body forming step of forming an element body including a coil conductor inside and containing metal magnetic particles and a resin; an exposing step of exposing an external terminal connection region of the coil conductor from the element body; a particle removing step of removing the metal magnetic particles from a mounting surface of the element body; and an external terminal forming step of forming an external terminal at a particle removal location where the metal magnetic particles have been removed in the particle removing step and the external terminal connection region of the coil conductor exposed in the exposing step.

<10> A method of manufacturing an inductor, including an element body forming step of forming an element body including a coil conductor inside and containing metal magnetic particles and a resin; an exposing step of exposing an external terminal connection region of the coil conductor from the element body; and an external terminal forming step of forming an external terminal on an inner side of an exposed region where the external terminal connection region of the coil conductor is exposed from the element body.

<11> The method of manufacturing an inductor according to <9> or <10>, further including an insulating layer forming step of forming an insulating layer on a surface of the mounting surface of the element body except a surface that comes into contact with the external terminal.

<12> The method of manufacturing an inductor according to any one of <9> to <11>, in which the element body forming step includes a step of forming a multilayer body by laminating magnetic layers containing the coil conductor and the metal magnetic particles, and a firing step of firing the multilayer body.

<13> The method of manufacturing an inductor according to any one of <9> to <12>, in which the exposing step is implemented by grinding the mounting surface of the element body.

<14> The method of manufacturing an inductor according to <9> or according to <11> or <12> as dependent on <9>, in which the particle removing step is implemented by etching with an acidic solution.
<15> The method of manufacturing an inductor according to any one of <9> to <14>, in which the external terminal forming step is implemented by electroless plating.

The present disclosure can be used for an inductor with reduced abnormal formation of an external terminal.

What is claimed is:

1. An inductor comprising:
an element body including a coil conductor inside, and including metal magnetic particles and a resin; and
an external terminal at a mounting surface of the element body and electrically connected to the coil conductor, wherein
the element body includes
a first principal surface and a second principal surface opposed to each other in a height direction,
a first end surface and a second end surface opposed to each other in a length direction which orthogonal to the height direction, and
a first side surface and a second side surface opposed to each other in a width direction orthogonal to the length direction and the height direction,
the external terminal includes
a coil conductor connection region on an exposed region where the coil conductor is exposed from the element body in see-through plan view from the mounting surface side of the element body, and
an overlap region overlapping the element body, and
an average length of contact of the metal magnetic particles with the external terminal relative to a length of the overlap region of the external terminal in a cross-section taken from the mounting surface side of the element body in the height direction of the element body along the length direction of the element body at a position where the cross-section passes through the external terminal and the coil conductor connection region is equal to or below 10%.

2. An inductor comprising:
an element body including a coil conductor inside, and including metal magnetic particles and a resin; and
an external terminal at a mounting surface of the element body and electrically connected to the coil conductor, wherein
the external terminal is on an inner side of an exposed region where the coil conductor is exposed from the element body in see-through plan view from the mounting surface side of the element body.

3. The inductor according to claim 1, wherein
the metal magnetic particles have been removed from the mounting surface of the element body.

4. The inductor according to claim 1, wherein
the metal magnetic particles have been removed from a surface of the element body other than the mounting surface.

5. The inductor according to claim 3, wherein
the external terminal extends into recesses in the mounting surface of the element body by removing the metal magnetic particles.

6. The inductor according to claim 1, wherein
the mounting surface of the element body includes an insulating layer covering a surface except a surface in contact with the external terminal.

7. The inductor according to claim 6, wherein
the insulating layer extends into recesses in the mounting surface of the element body by removing the metal magnetic particles.

8. The inductor according to claim 1, wherein
a depth of recesses is from a maximum particle size of the metal magnetic particles to twice the maximum particle size of the metal magnetic particles.

9. The inductor according to claim 2, wherein
the metal magnetic particles have been removed from the mounting surface of the element body.

10. The inductor according to claim 2, wherein
the metal magnetic particles have been removed from a surface of the element body other than the mounting surface.

11. The inductor according to claim 4, wherein
the external terminal extends into recesses in the mounting surface of the element body by removing the metal magnetic particles.

12. The inductor according to claim 2, wherein
the mounting surface of the element body includes an insulating layer covering a surface except a surface in contact with the external terminal.

13. The inductor according to claim 2, wherein
a depth of recesses is from a maximum particle size of the metal magnetic particles to twice the maximum particle size of the metal magnetic particles.

14. A method of manufacturing an inductor, comprising:
forming an element body including a coil conductor inside, and including metal magnetic particles and a resin;
exposing an external terminal connection region of the coil conductor from the element body;
removing the metal magnetic particles from a mounting surface of the element body; and
forming an external terminal at a particle removal location where the metal magnetic particles have been removed in the particle removing and the external terminal connection region of the coil conductor exposed in the exposing.

15. A method of manufacturing an inductor, comprising:
forming an element body including a coil conductor inside, and including metal magnetic particles and a resin;
exposing an external terminal connection region of the coil conductor from the element body; and
forming an external terminal on an inner side of an exposed region where the external terminal connection region of the coil conductor is exposed from the element body.

16. The method of manufacturing an inductor according to claim 14, further comprising:
forming an insulating layer on a surface of the mounting surface of the element body except a surface that comes into contact with the external terminal.

17. The method of manufacturing an inductor according to claim 14, wherein
the element body forming includes
forming a multilayer body by laminating magnetic layers including the coil conductor and the metal magnetic particles, and
firing the multilayer body.

18. The method of manufacturing an inductor according to claim 14, wherein the exposing is implemented by grinding the mounting surface of the element body.

19. The method of manufacturing an inductor according to claim 14, wherein the particle removing is implemented by etching with an acidic solution.

20. The method of manufacturing an inductor according to claim 14, wherein the external terminal forming is implemented by electroless plating.
